(19) United States
(12) Patent Application Publication
(10) Pub. No.: US 2023/0237397 A1
(43) Pub. Date: Jul. 27, 2023

(54) METHOD AND SYSTEM FOR PRODUCTION OPTIMIZATION

(71) Applicant: PINAK DATTARAY, NOIDA (IN)

(72) Inventor: PINAK DATTARAY, NOIDA (IN)

(73) Assignee: PINAK DATTARAY, NOIDA (IN)

(21) Appl. No.: 18/127,276

(22) Filed: Mar. 28, 2023

(51) Int. Cl. G06Q 10/0631

(52) U.S. Cl. CPC G06Q 10/06313; G06Q 10/06314

(57) ABSTRACT

The invention enables a system for generating a daily production plan and assigning the products to be painted for a plurality of Paint Shop production lines.

Embodiments of the present disclosure may include a System for generating a daily production plan and assigning the products to be painted for a plurality of Paint Shop production lines, including inventory data receiving means. Embodiments may also include previous backlog production data receiving means. Embodiments may also include order data means for receiving detail about the products to be painted. Embodiments may also include constraints configuration means for configuration of the constraints of the production system. Embodiments may also include production plan generation means for generating a production plan based on the inventory data (a), the previous backlog production data (b), the order data details (c), and the constraints of the production system (d).

The product optimization tool also includes a system consisting of a user interface for inputting and modifying process settings, as well as a means for generating reports on paint shop performance. The system mainly involves utilizing an objective function to find the optimal production and painting of the products.

### FIELD OF THE INVENTION

The present invention relates to the field of product optimization tool and particularly to a system and method for optimizing paint shop operations. The tool utilizes real-time data collection and analysis techniques to monitor and adjust various parameters such as the sequence of the products, planning of stock-keeping units (SKU), and paint usage. The tool alsoincludes a user interface for inputting and modifying process settings, as well as a means for generating reports on paint shop performance.

### BACKGROUND OF THE INVENTION

Earlier manufacturers typically used manual methods to plan and schedule production in paint shops. This often involved a significant amount of time and resources spent on creating and maintaining schedules, as well as tracking and analyzing production data. Additionally, without the aid of optimization tools, it could be difficult to identify and address inefficienciesin the production process. Production facilities have frequently faced various problems relating to product optimization. When production facilities work on several different products requiring variable processing times on different workstations, optimizing production is not a trivial problem. Moreover, typical product sequencing can sometimes miss the advantages that derive from working on several products simultaneously.

The paint shop optimization tool is a system designed to help manufacturers optimize the production process for painting products, such as furniture, automobiles and various other appliances. These tools can be used to optimize the layout of the paint shop, schedule production, and manage the flow of materials and products through the facility. Some of thekey features of paint shop optimization tools include the ability to model and simulate the paint shop process, generate production schedules, and analyze data to identify inefficiencies. These tools can also help manufacturers to reduce costs, improve production efficiency, and increase the quality of the final product.

Paint shops are an essential aspect of many industrial and manufacturing operations. The advantage of the paint shop optimization tool over a traditional manual method is to provide real-time monitoring and control of paint shop operations, the tool can significantly improve efficiency and reduce costs. The tool can also help to identify and resolve issues such as equipment malfunction, which can save significant amounts of time and resources. Additionally, the tool can be used to generate reports on paint shop performance, which can be used to identify trends and further improve operations.

Therefore, there is a need to develop a paint shop optimization tool which is effective for sequencing the products, sequencing the paint colour, determining the production line to be used for painting, and planning productions of various Stock Keeping Units (SKU’s). Further, itwill also improve the efficiency of the production process, reduce costs, and increase the quality of the final product.

With the introduction of paint shop optimization tools, manufacturers will be able to more easily and effectively plan and schedule production, as well as quickly identify and address any issues that may arise.

### OBJECT OF THE INVENTION

The primary object of the present invention is to provide a paint shop optimization tool which can be used to improve the efficiency and effectiveness of the production process in a paint shop.

Another object of the present invention is to plan the production of various Stock Keeping Units (SKUs)

A further object of the present invention is to plan the production i.e., items to be produced, their sequence, their production line and their optimum quantity.

### SUMMARY OF THE INVENTION

The present invention enables a system of paint shop optimization tool that addresses these issues by providing real-time monitoring and control of paint shop operations. The tool includes a sensor system for collecting data on paint usage, equipment performance, and labour efficiency. This data is then analyzed in real-time to identify areas for improvement and to adjust various process parameters accordingly.

The tool also includes a user interface for inputting and modifying process settings, as well as a means for generating reports on paint shop performance. The tool has been designed to plan the production i.e., the items to be produced, their sequence, their production line and their optimum quantity. The system can also be used to generate an input report, a Buffer penetration report and an output report.

Embodiments of the present disclosure may include a System for generating a daily production plan and assigning the products to be painted for a plurality of Paint Shop production lines, including inventory data receiving means. Embodiments may also include previous backlog production data receiving means. Embodiments may also include an order data means for receiving detail about the products to be painted.

Embodiments may also include constraints configuration means for configuration of the constraints of the production system. Embodiments may also include production plan generation means for generating a production plan based on the the inventory data (a), the previous backlog production data (b), the order data details (c), and the constraints of the production system (d).

Embodiments may also include new backlog production data generation means for a generation of new backlog data based on the the inventory data (a), the previous backlog production data (b), the order data details (c), the constraints of the production system (d)and the production plan (e). Embodiments may also include product allocation and scheduling means for allocation of the products for painting to the production line and scheduling the painting on the the selected production line based on the production goal.

Embodiments of the present disclosure may also include, the system for generating a daily production plan and assigning the products to be painted for a plurality of Paint Shop production lines. In some embodiments, the input received by the means of receiving inventory data consists of the number of units in stock in the warehouse, number of units in-transit stock, number of units in stock at the plant, no of pending orders, branch targets, market demand forecast, and information about the existing and in-demand stock units.

Embodiments of the present disclosure may also include, the system for generating a daily production plan and assigning the products to be painted for a plurality of Paint Shop production lines. In some embodiments, the previous backlog production data may be made for one or more product details that were not manufactured during previous manufacturing operation on the production lines.

Embodiments of the present disclosure may also include, the system for generating a daily production plan and assigning the products to be painted for a plurality of Paint Shop production lines. In some embodiments, the order data provide details about the product to be painted, product dimensions, product characters, product types, desired color and quantities of products.

Embodiments of the present disclosure may also include, the system for generating a daily production plan and assigning the products to be painted for a plurality of Paint Shop production lines. In some embodiments, the production plan consists of the paint shop timetable, sequence of the products to be painted, quantity of the product, the color of the product, changeover time, etc.

Embodiments of the present disclosure may also include, the system for generating a daily production plan and assigning the products to be painted for a plurality of Paint Shop production lines. In some embodiments, the constraints configuration means can be used to configure constraints for production of the quantity of the product, changeover constraints, exclusivity constraints, size constraints, manpower constraints, shape constraints or combination thereof.

Embodiments of the present disclosure may also include, the system for generating a daily production plan and assigning the products to be painted for a plurality of Paint Shop production lines. In some embodiments, the new backlog production data may be made for one or more product details that will not be manufactured during the manufacturing operation on the production lines.

Embodiments of the present disclosure may also include, the system for generating a daily production plan and assigning the products to be painted for a plurality of Paint Shop production lines. In some embodiments, product allocation and scheduling means allocates the product to the production line from a plurality of available production lines and schedules the production in the plurality of production line.

A product optimization tool for a paint shop is a system that helps manufacturers optimize the production process for painting specific products, such as furniture, automobiles and various other appliances. Some of the key features of a product optimization tool for a paintshop include the ability to:
1. Model and simulate the paint shop process for specific products, such as types of furniture or other appliances.
2. Generate production schedules that consider the unique requirements of the product being painted.
3. Keep track of the production stock by planning the production of various SKUs
4. Analyze data to identify inefficiencies in the production process for specific products.
5. Optimize the use of resources, such as paint and labour, to minimize costs and increase efficiency.
6. Help manufacturers to improve the quality of the final product by analyzing and improving the painting process.
7. Providing colour coding for furniture items based on their stock
8. Grouping of the items to be manufactured

### BRIEF DESCRIPTION OF DRAWINGS

The accompanying drawings, which are incorporated in and constitute a part of this disclosure, illustrate exemplary embodiments and, together with the description, serve to explain the disclosed principles.

FIG. 1 illustrates the screen representation of input window, which provides the maximum capacity constraint details, where the user needs to upload the Buffer penetration report, Backlog line 1 report and Backlog line 2 report

FIG. 2 illustrates the screen representation of paint shop scheduler, that consists of maximum capacity constraints, which can be customize as per the requirement. It also includes report details, where the user needs to upload Buffer penetration report, BM report, Multipack BM report, MES inventory (optional), Backlog file (optional) and click on generate option, with which a personalized paint scheduler is generated.

FIG. 3 illustrates the screen representation of the Buffer penetration report, it contains details like the number of units in stock, number of units in transit stock, number of units in stock at the plant, representation of market demand based on pending orders and Branch targets are represented in the Buffer Penetration Report. FIG. 4 illustrates the screen representation of the Backlog files

FIG. 5 illustrates the output report provided by the system. It mainly consists of Paint shop Time-table line 1, Paint shop Time-table line 2, Backlog, Daily plan and Sequenced plan reports. These reports can be downloaded by users.

FIG. 6 illustrates the screen representation of the unsequenced schedule, which is a part of the output report.

FIG. 7 illustrates a block diagram of a System, according to some embodiments of the present disclosure.

FIG. 8 illustrates a block diagram of the system, according to some embodiments of the present disclosure.

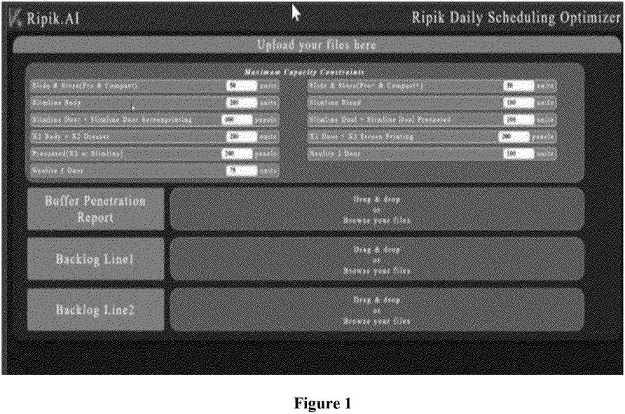

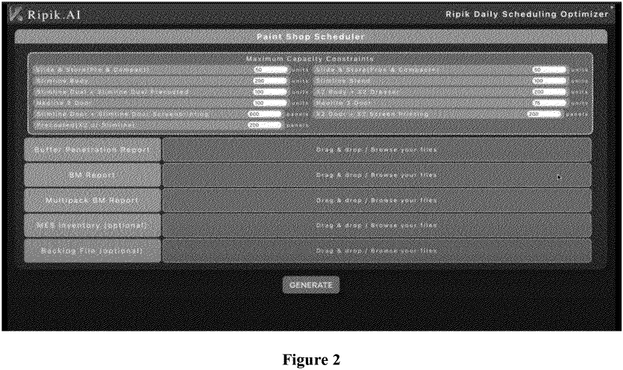

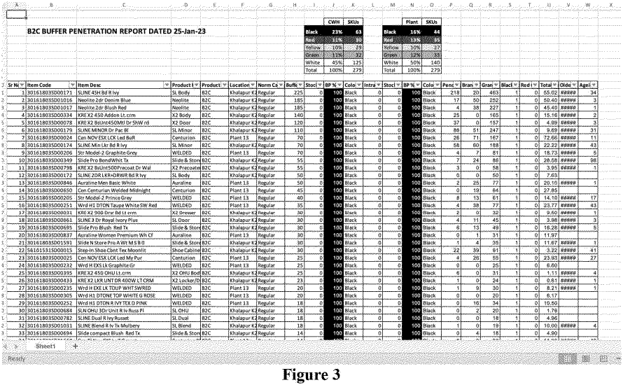

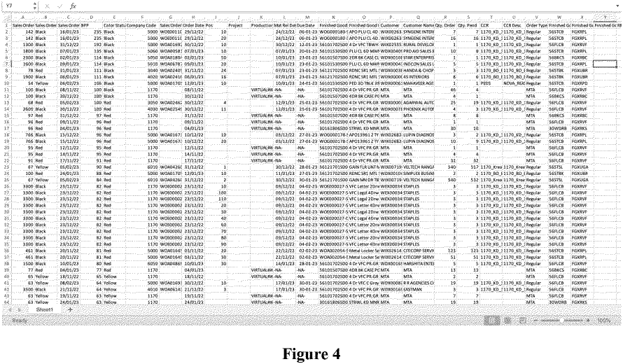

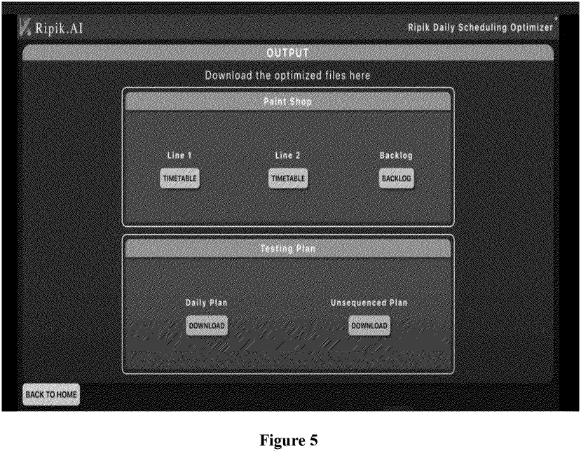

### BRIEF DESCRIPTION OF THE INVENTION

A Product optimization tool according to a preferred embodiment of the present invention is herein described in the following description

### DETAILED DESCRIPTION OF THE INVENTION

A Product optimization tool thereof is herein described with numerous specific details to provide a complete understanding of the invention. However, these specific details are exemplary details and should not be treated as a limitation to the scope of the invention.

Throughout this specification, the word “comprises” or variations such as “comprises or comprising”, will be understood to imply the inclusions of a stated element, integer or step, or group of elements, integers, or steps, but not the exclusions of any other element, integer or step or group of elements, integers, or steps.

A method is described herein for optimal production in a paint shop facility. The disclosed tool is a product planning tool that has been specifically designed to help the paint shop plan its production operations. It allows users to plan the furniture items that will be painted, the sequence in which they will be painted, the production line that will be used, the optimum quantity of each furniture item to be painted and the record of various Stock Keeping Units (SKU’s).

This can be accomplished through a system, which includes a user-friendly interface, and it also allows easy input and management of production data.

The production amount and production sequence of various products have to be rationalized based on user requirements, changeovers needed during production, constraints of the product, sequence of paint colour, variation of furniture size, determination of next production line to be used for painting, planning production and real-time stock availability. The optimal production tool found using this method described herein can help establish useful resource allocation and help to effectively sequence the production.

The processing module acquires data from the user, wherein the user uploads production information like Buffer penetration report, Backlog line 1 report and Backlog line 2 report via the input screen which contains the maximum capacity constraint details, wherein the Buffer Penetration Report contains details of the number of units in stock, number of units in transit stock, number of units in stock at the plant, representation of market demand based on pending orders and Branch targets are represented in the Buffer Penetration Report. It gives real-time information about the existing and in-demand stock units, which is signified by four major colour codes; White / Green / Black / Yellow, wherein the colour white indicates that the entire product is available in stock, and Black colour indicates that the product is low on inventory, Green and Yellow colour indicates the existing stock in inventory in percentage form.

Backlog file 1 and Backlog file 2, indicate the item that is not considered in the maximum constraint. These items are the ones which were not produced on the predicted date and hence are added to the backlog file.

The above-obtained data is further processed by the system which results in a set of output data, that is represented by an Output Report. This report Output is the end part of the production line. Once previously selected various types and quantities of products and thecolour coating, the user can download the optimized files in this section. It consists of Paint shop line 1, Paint shop line 2, Daily plan and Unsequenced Plan. This report is available for downloading purposes, wherein the paint shop line 1 and Paint shop line 2 contain the production line timetable and backlog details, the unsequenced schedule represents the item Codes and their quantities which are selected by the optimizer based on various family and quantity constraints. This plan does not consider the Paint Shop time constraints in a day. It is the first thing generated by the system, which includes a description of products, family powdercoating colour, quantity, minimum order quantity, priority and colour status of the product.

The daily plan represents the sequence of colour, quantity and time that a production line has to optimize for the production of a product. Represents the items that need to be manufactured and painted. It shows the item codes, and their respective quantities present in both timetables. The daily plan is used to convey to the metal shop about the items that need to be kept ready on (n+4) day for the paint shop.

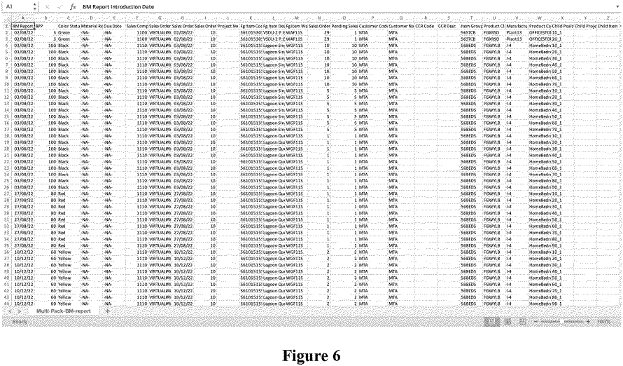

As depicted in FIG. 6, which is a block diagram that describes a System 100, according to some embodiments of the present disclosure. In some embodiments, the System 100 may include inventory data 110 receiving means, previous backlog production data 120 receiving means, an order data means 130 for receiving detail about the products to be painted, constraints configuration means 140 for configuration of the constraints of the production system, product allocation 170, and scheduling means 180 for allocation of the products for painting to the production line and scheduling the painting on the the selected production line based on the production goal.

In some embodiments, the System 100 may also include production plan generation means 150 for generating a production plan based on the the inventory data 110 (a), the previous backlog production data 120 (b), the order data details (c), and the constraints of the production system (d). The System 100 may also include new backlog production data generation means 160 for a generation of new backlog data based on the the inventory data 110 (a), the previous backlog production data 120 (b), the order data details (c), the constraints of the production system (d)and the production plan (e).

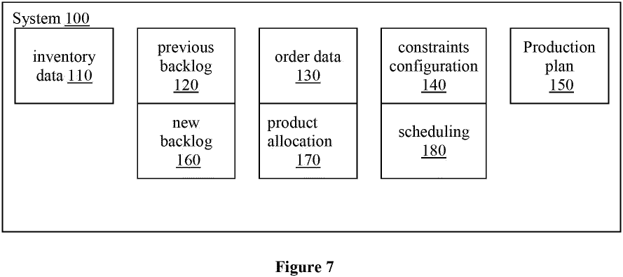

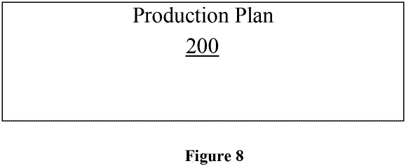

As depicted in FIG. 7, which is a block diagram that describes the system, according to some embodiments of the present disclosure. In some embodiments, the system for generating a daily production plan 200 and assigning the products to be painted for a plurality of Paint Shop production lines including the paint shop timetable, sequence of the products to be painted, quantity of the product, the color of the product, changeover time, etc.

We claim:

1. A System for generating a daily production plan and assigning the products to be painted for a plurality of Paint Shop production line, comprising:
a) inventory data receiving means;
b) previous backlog production data receiving means;
c) an order data means for receiving detail about the products to be painted;
d) constraints configuration means for configuration of the constrains of the production system;
e) production plan generation means for generating production plan based on the said inventory data (a), said previous backlog production data (b), said order data details (c) and said constraints of the production system (d);
f) new backlog production data generation means for generation of new backlog data based on the said inventory data (a), said previous backlog production data (b), said order data details (c), said constraints of the production system (d) and said production plan (e);
g) product allocation and scheduling means for allocation of the products for painting to the production line and scheduling the painting on the said selected production line based on the production goal.

2. The system for generating a daily production plan and assigning the products to be paintedfor a plurality of Paint Shop production line, as claimed in claim (1), wherein the input receivedby the means of receiving inventory data consists of number of units in stock in warehouse, number of units in-transit stock, number of units in stock at the plant, no of pending orders, branch targets, market demand forecast and information about the existing and in-demand stockunits.

3. The system for generating a daily production plan and assigning the products to be painted for a plurality of Paint Shop production line, as claimed in claim (1), wherein the previous backlog production data is made for one of more product details that were not manufactured during previous manufacturing operation on the production lines.

4. The system for generating a daily production plan and assigning the products to be painted for a plurality of Paint Shop production line, as claimed in claim (1), wherein the order data provide details about the product to be painted, product dimensions, product characters, product types, desired color and quantities of products.

5. The system for generating a daily production plan and assigning the products to be painted for a plurality of Paint Shop production line, as claimed in claim (1), wherein the production plan consists of the paint shop timetable, sequence of the products to be painted, quantity of the product, color of the product, changeover time, etc.

6. The system for generating a daily production plan and assigning the products to be painted for a plurality of Paint Shop production line, as claimed in claim (1), wherein the constraints configuration means can be used to configure constraints for production of the quantity of the product, changeover constraints, exclusivity constraints, size constrains, manpower constraints, shape constraints or combination thereof.

7. The system for generating a daily production plan and assigning the products to be painted for a plurality of Paint Shop production line, as claimed in claim (1), wherein the new backlog production data is made for one of more product details that will not manufactured during the manufacturing operation on the production lines.

8. The system for generating a daily production plan and assigning the products to be paintedfor a plurality of Paint Shop production line, as claimed in claim (1), wherein product allocationand scheduling means allocates the product to the production line from a plurality of available production lines and schedules the production in the plurality of production line.
